(19) United States
(12) Patent Application Publication
(10) Pub. No.: US 2005/0254813 A1
(43) Pub. Date: Nov. 17, 2005

(54) Apparatus for including user-provided message with still pictures

(76) Inventor: Henry Brendzel, Millburn, NJ (US)

Correspondence Address: Henry T. Brendzel, P.O. Box 574, Springfield, NJ, 07081, US

(21) Appl. No.: 10/844,186

(22) Filed: May 12, 2004

(51) Int. Cl. G03B 17/24

(52) U.S. Cl. 396/311

(57) ABSTRACT

A still cameras that records a short message with each taken picture as a label for the picture, with means that permit eventual developing of relatively permanent facsimiles of the pictures that include a visual representation of the message.

### BACKGROUND OF THE INVENTION

This invention relates to still picture cameras as well as to apparatus and method for creating relatively permanent facsimiles of the pictures taken by the cameras.

People who go on vacation often take still pictures of people and places at various points/times along the way. Typically, the pictures, when taken with a conventional film-type camera, are developed sometime after returning from the vacation, and thereafter the developed pictures are placed in an album. The same is true with digital pictures, although often the digital pictures are stored in a computer rather than, or in addition to, transferring the pictures to paper. Alas, all too often people forget to record the circumstances surrounding the particular pictures, and later forget those circumstances. This is a problem that would be highly desirable to overcome.

### SUMMARY OF THE INVENTION

An advance in the art is achieved by providing means, associated with the still cameras (film, or digital), for recording a short message in association with each of the pictures that the still camera captures, essentially contemporaneously with the picture taking. When the pictures are regenerated for the viewing pleasure of people, each picture presents the previously recorded message in a manner that is perceivable by the people who are viewing the pictures.

In an illustrative embodiment for film cameras, the message comprises a spoken speech passage that is stored in a memory chip situated within the cartridge containing the camera's photographic film. When the pictures that are captured on the individual frames of the film are developed, the speech messages that are maintained in the memory chip and that are associated with respective frames of the film are converted to text by means of conventional text to speech processing, and the text is imaged on the picture that is printed for each of the frames.

In an illustrative embodiment for digital cameras, the recorded messages that are associated with each picture that is captured by the camera are stored in the memory in which the image is stored, and presented to whatever display means that a user chooses to use. In the case where the display means is a printer that memorializes the images on paper, the associated messages are printed in association with each of the respective printed pictures. In the case of the picture being downloaded to a computer, the associated message is downloaded as well and, either concurrently with the downloading or thereafter, the message is converted to text by means of conventional speech to text processing. Alternatively, the speech is outputted as speech.

In another illustrative embodiment (for either type of camera), the camera includes a processor that converts the speech to text and, optionally, embeds the text in the picture.

### BRIEF DESCRIPTION OF THE DRAWING

FIG. 1 depicts various elements of a still film-type camera in accord with the principles disclosed herein;

FIG. 2 depicts various elements of a still digital-type camera in accord with the principles disclosed herein;

FIG. 3 shows a film cartridge that includes a memory chip;

FIG. 4 presents a flowchart of a method in accord with the principles disclosed herein;

FIG. 5 a block diagram for developing film used in a camera in accord with the principles disclosed herein; and

FIG. 6 presents an alternative still film-type camera in accord with the principles disclosed herein.

### DETAILED DESCRIPTION

FIG. 1 depicts a number of elements of a still-picture camera that employs conventional film. It comprises an imaging system 10 that includes a lens 11 and an associated lens and shutter control apparatus 12 that is controlled by processor 15. Initially, before a picture is taken, moveable mirror 16 is positioned so that the image that passes through lens 11 is diverted to image receptor 17; e.g., a CCD array, which sends the received information to processor 15. Processor 15 analyzes the information and controls the focal length of lens 11, its aperture, and the speed of a lens shutter (not explicitly shown) to create a proper image for picture taking. When the user of the camera wishes to capture the image (in the American English vernacular, the phrase “take a picture” is used much more often than the phrase “capture the image” and, therefore, the former phrase is sometimes used herein), the user presses button 14 that activates processor 15. The latter moves the mirror out of the way, opens the shutter for the necessary time interval, and the image passes through lens 11 to photographic film 13, wherein the image is chemically captured. Of course, the above is merely illustrative. For example, instead of a mirror 16 that is moved out of the way, one may employ a beam splitter.

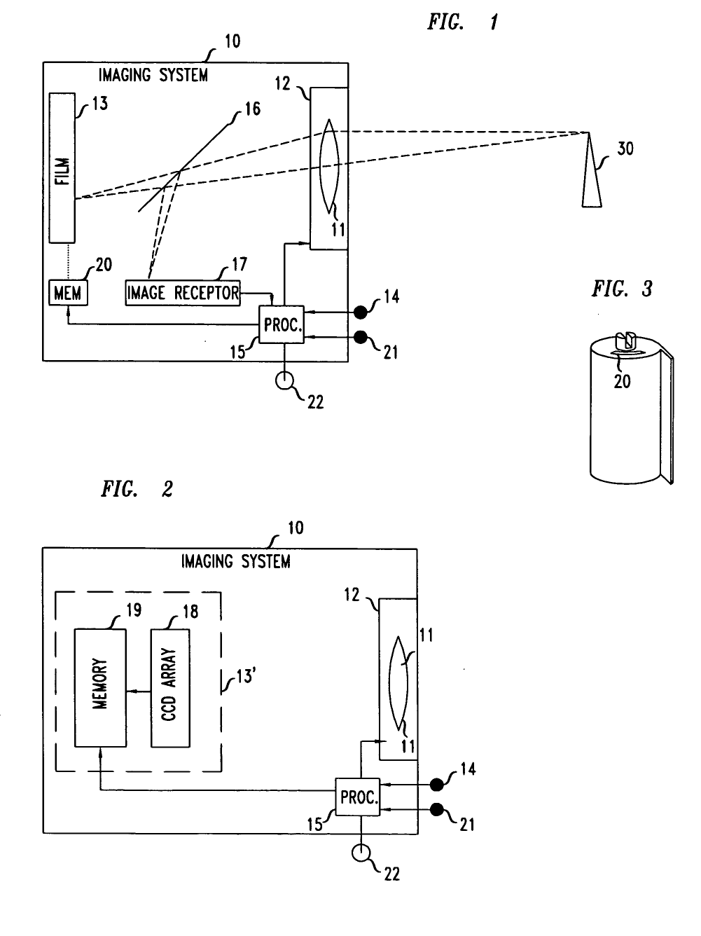

In a digital camera, shown in FIG. 2, the operation is essentially the same, except that there is no need for mirror 16 and image receptor 17. Rather, image receptor 13′ is employed to replace film 13, which receptor typically comprises a two-dimensional charge coupled devices (CCD) array 18, and memory 19 that is coupled to the CCD array. Array 18 develops electrical signals at the individual element of the CCD array in response to impinging light and, under control of button 14, those electrical signals are stored in memory 19.

Photographic Film Cameras

As indicated above, it is an objective of this invention is to record information that is provided by a user, often contemporaneously with the taking of a picture. To meet this objective, the FIG. 1 illustrative embodiment includes memory 20 that is associated with the photographic film 13. The association is at least logical, if not also physical.

Although memory 20 can be situated within the camera, the illustrated embodiment contemplates memory 20 to be part of the film cartridge; i.e., physically associated. As an aside, in the context of this disclosure, the term “cartridge” is broad, encompassing rolls, and other means of packaging film for still cameras. Accordingly, FIG. 3 depicts a photographic film cartridge embodiment that is of conventional design, except for the fact that it includes memory 20, with associated contacts situated on one of the end portions thereof. When the film cartridge of FIG. 3 is loaded into the camera, the electrical contacts of the depicted memory chip are coupled to controller 15 to realize the arrangement shown in FIG. 1.

In addition to memory 20, the FIG. 1 embodiment includes means 22 for the camera's user to provide input to the camera, and button 21 that is coupled to processor 20, which button controls the recording of information that processor 15 accepts from input means 22 and stores in memory 20. It is noted that the functionality of button 21 can be achieved through other means (e.g., with button 14). For sake of simplicity of this disclosure, however, a distinct button 21 is assumed to be used. Means 22 can comprise a variety of elements, but it is expected that a microphone will be the most popular means.

In addition to storing information that is provided by the user, it is an objective of this invention to create pictures that are augmented with the information that is provided by the user. The information may be processed (perhaps even to a significant degree) before it is stored, but that is not a requirement. For example, when means 22 is a microphone and the input is speech that is provided by the user, a viable embodiment results with the mere conversion of the speech to electrical signals and the storing of those signals in memory 20. In many applications, however, converting the speech into text and storing the text will prove to be perfectly satisfactory. It is realized, for example, that the interval between picture taking is typically many seconds, which is amble time for processing speech into text.

The general operational philosophy is that when a user is given an opportunity to record an utterance of a relatively short duration (in the television arts, such utterances are sometimes called, a “sound byte,” and in education arts such utterances might be called “speech strips”) shortly after taking a picture. Assuming that the recording is that of voice (which, for sake of simplicity, is assumed throughout the disclosure), the utterance of the user is recorded. This is accomplished by block 100 in FIG. 4, which depict a flow diagram of a process carried out in processor 15.

Eventually, the film is converted to photographs that are printed on paper, and it is the objective of this invention to create a human-readable facsimile of the utterance on the photographs. The process associated with the creation of the relatively permanent facsimile, i.e., creating the “hard copy” photographs printed on photographic paper, is shown in step 200.

Though the process of step 100 can be logically quite complex, if many different options are given to the user (for example, allowing the user to record an utterance shortly before taking a picture, or after taking the picture, even a very simple process achieves the desired results.

In the illustrative embodiment of FIG. 4, which allows the recording only for a short time interval following the taking of a picture, when button 14 is pressed, control passes to step 101, where the picture is captured in the conventional manner, and control is passed to step 102. Step 102 initiates a timer T1 that enables the recording of a speech utterance, and passes control to step 103. Step 103 ascertains whether, before timer T1 expires, button 21 is pressed. If, before the timer's interval expires, button 21 is pressed, control passes to sep 104, where feedback is provided to the user (audible, or visual), the user's speech input is accepted, processed, and stored in association with the taken picture.

The processing of step 104 may be simply a conversion of the audio signal to digital format, but it can be more than that. In fact, employing a speech-to-text algorithm yields a very attractive embodiment. Speech to text algorithms have existed for a number of years, so a number of options are available to the artisan for selecting software modules to be included in processor 15 for carrying out the processing of step 107. The speech-to-text engine of IBMs' ViaVoice is an example of such algorithms. ScanSoft offers a similar software module.

It may be noted that conventional movie film recording, as well as or video recording, comprises a collection of still images (frames) that appear at a rate that is faster than what a humane eye can discriminate, resulting in a visual experience (upon playback) of continuous action. Nevertheless, there is a finite time interval between frames. However, the sound that is recorded in such movie film and video recording is essentially continuous, so one might assert that there is a correspondence between a frame and a snippet of recorded sound. That is not what this invention contemplates. Rather, the recorded sound of this invention is much longer in duration than the duration between successive captures of images. It is contemplated that the recording associated with an image will be at least on the order of a second or more, which is more than an order of magnitude longer than sound snippets that may be said to be associated with frames of a movie or a video recording. For purposes of this disclosure, a sound of a time interval of more than one second is called label time.

The above description focuses on when the sound recording is initiated, rather than the duration of the label time. That duration can be fixed by the camera's manufacturer, preset by the user, or dynamically controlled. For example, camera can be set so that the user presses button 21 to initiate the sound recording, and presses it again to stop recording. The difference between those two instances is the label time.

It is expected that, as is the case with all picture-taking sessions, eventually the last frame of the film is exposed, and the next step is to develop the film, and print pictures on photographic paper. In accord with the principles of this invention, the film to be developed advantageously is developed essentially contemporaneously with the retrieval and processing of the information contained in memory 20. Processing may be simply transcribing the speech information—for example, storing it in a computer memory. However, the processing may also encompass a conversion of the speech to text.

Step 200 of FIG. 4 describes the development process. In step 201 the film is developed and the utterance information is retrieved from memory 20. In step 202 the utterance information is processed to develop a text message, and in step 203 the image that is on the film is transferred to photographic paper and, concurrently, the text of the utterance is also transferred to the photographic paper.

In accord with the illustrated embodiment, the text of the utterance is printed at the picture's white border, or embedded in the picture area. Such printing can be effectively accomplished photographically, as shown, for example, in FIG. 5.

FIG. 5 includes mechanism 51 for holding the developed film, a light source 52, optical magnification unit 53, and mechanism 54 for holding photographic paper. To print pictures, a film is inserted into mechanism 51, light is shone through the film and through unit 53 to fall on the photographic paper. Thereafter, conventional processes are carried out to fix the image that was placed on the photographic paper.

The FIG. 5 apparatus is augmented with processor 55, and imaging unit 56 that outputs character images that shine on the photographic paper. Placing the text obtained from memory 20 into processor 55 (or placing the audio information from memory 20 into processor 54 and converting it to text), allows processor 55 to output the text associated with picture N when picture N is being imaged onto the photographic paper. The result is a picture, with the text embedded therein.

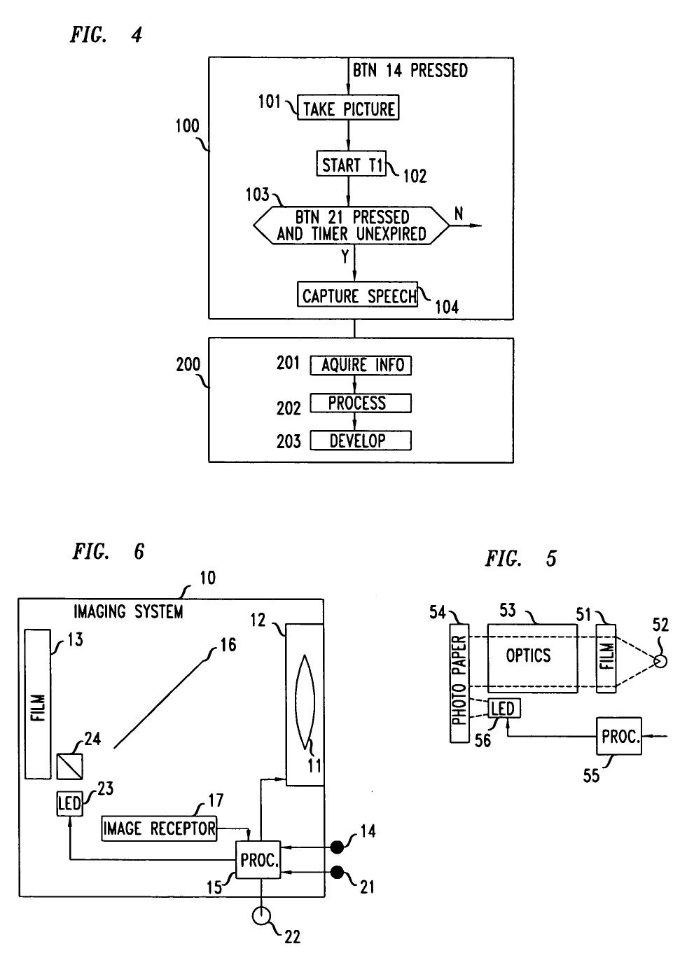

FIG. 6 presents an embodiment that does not contemplate having a memory in the camera (be it embedded in the film cartridge, or otherwise). Rather, FIG. 6 includes an imaging element 23 that is controlled by processor 15, and a beam splitter 24. Beam splitter 24 allows an image that is generated by the imaging element (for example, an LED array) to be superimposed on the image that the camera is capturing. Of course, in this embodiment it is necessary for the combination of processor 15 and imaging element 23 to process the input supplied by the user into human-readable form.

It should be noted that the process of recording the user-supplied information that is described above needs to be modified not to provide the option of recording user-provided information after the taking of the picture. In such a modified process, which is simpler than the process described above, the user must first press button 21, record the utterance, have processor 15 convert the utterance to text and then, when button 14 is pressed, the have processor 15 control the shutter the camera in a conventional way and, in addition, outputting the utterance to imaging element 23. The latter function is not unlike the placing of a time and date on a picture, except for the novel notion of having that text be user controlled.

Digital Cameras

To meet the above-mentioned objective for digital cameras (in contrast to the film cameras discussed above), no additional hardware is necessarily required over and above the hardware that digital cameras already have, except for means 22 and the functionality of button 21. Adding a microphone for means 22, for example, is a pretty trivial augmentation.

As in the above-described film camera, the information can be injected shortly after a picture is taken, whereupon the user-provided information is stored in the same memory that stores the actual pictures, perhaps in the form of .jpg files, for speech, and .txt files for text.

The user-provided information can be stores separately from the associated pictures, and it can also be stored within the file, such as in a trailer of the file that can be easily segregated. In this manner, whether an image of a picture is retrieved in the digital camera (for local previewing), or is retrieved from a computer to which pictures of the digital camera were downloaded, it is relatively easy to separate the image from the user-provided information, to process the user-provided information, and to display it.

One advantage of this approach is that the user-provided information can be altered at any time. This feature may be quite desirable by some users when away on vacation and the user wishes to employ unusual words (often foreign words, such as names of places). It may be desirable to be able to review the recorded speech and edit it, or to review the algorithmically generated text and edit the text. As for the former, it is straight forward to enable the camera to re-record a label. As to the latter, means would need to be provided to allow the user to enter/edit text; perhaps with a dial pad not unlike the dial pad of a cellular telephone.

On the other hand, processor 15 can include a pixel-salting software module that follows the module that converts speech to text, where the pixel-salting module converts text to pixel groupings that form letters. The signals developed by the pixel-salting module are added to the signals that are already present in the memory and, thus, after the digital camera takes a picture, the user-supplied text may be added to the stored image. This creates pictures with embedded text that can be previewed while still in the camera's memory, and can also be viewed when downloaded to a computer. Converting the digital images to paper images, of course, preserves the text.

The above disclosure presents the principles of this invention by way of illustrative embodiments. It should be realized, however, that various other additions and modifications can be made without departing from the spirit and scope of this invention, as defined in the accompanying claims. To give an example of a modification, although the disclosure above speaks only of text as the compressed form of utterances, one should realize that other forms are also acceptable; for example the phonemes of the utterance also form a useable, compressed representation of utterances. To give an example of an addition, there has been no mention of the duration of the utterance that may be recorded. That, of course would be a design choice that relates to the size of memory 20, and to the manner in which the information is stored (raw, or compressed).

As indicated above, one feature of this invention is that the recording of information (for example, speech) is enabled for a relatively long time—compared to the time it takes to take a picture, or the time it takes successive pictures in a movie camera or a video camera. Another way to characterize this feature is that the recording of information is unrelated to any time constraints pertaining to the picture taking. In particular, also the above mentions no upper limit on the duration of the information recording. In connection with film cameras, where the primary motivation is to create a label that makes up a permanent feature of the captures image, it is expected that users will record only short utterances; perhaps less than 10 words' worth. With digital cameras, however, this self-imposed limitation might not occur. A user who is planning to show the digital picture through a computer-controller “slide show,” might be willing to utter and record a number complete sentences.

1. A camera containing an image receptor, an imaging system, and a picture-taking activator system for enabling light to pass through said imaging system and enabling said image receptor to capture a still image, the improvement comprising:
a user-input port;
a recording activator;
a memory; and
a processing module associated with said picture-taking activator system that is electrically coupled to said memory, to said user-input port, and to said recording activator, for receiving information from said user-input port responsive to said recording activator, processing said information, and storing a label time interval of the processed information in association with said captured still image.

2. The camera of claim 1 where said processing comprises a step of converting said received signals to digital form.

3. The camera of claim 1 where said processing includes a step of converting said received signals to a form adapted for visual display.

4. The camera of claim 1 where said processing includes a step of converting said received signals to text.

5. The camera of claim 1 where said processing module stores said input signals in compressed form.

6. The camera of claim 5 where said compressed form is created from speech parameters that are derived from an analysis of said input signals.

7. The camera of claim 1 where said processing module, when storing input signals received from said user-input port in response to activation by said recording activator under control of a user, stores said input signals for a time duration that is controlled by said user.

8. The camera of claim 1 where said recording activator is part of said picture-taking activator system.

9. The camera of claim 8 further comprising a sound recording terminator element.

10. The camera of claim 1 further comprising an element, responsive to said picture-taking activator system, or to said recording activator, that provides feedback to a user of said camera pertaining to input provided by said user to said user-input port.

11. The camera of claim 8 where said user-input port comprises a microphone.

12. The camera of claim 1 further comprising a receptacle, electrically coupled to said processing module and adapted to accept a removable memory element that contains said memory.

13. The camera of claim 12 where said removable memory element is a film cartridge that forms a part of said image receptor.

14. The camera of claim 1 where
said image receptor is a removable film cartridge,
said memory is embedded in said film cartridge,
said film element including an electrical connection, accessible outside said film cartridge, that is coupled to embedded memory, and
said camera further comprises an electrical connection element that couples said memory in said film cartridge to said processing module when said film cartridge is installed in said camera.

15. The camera of claim 1 further comprising a light emitting element coupled to said processing module that applies a light to said image receptor.

16. The cameral of claim 15 where said light applied by said light emitting element represents information supplied by a user to said user-input port.

17. The camera of claim 1 where said image receptor is other than photographic film.

18. The camera of claim 1 further comprising means for retrieving information from said memory while said memory is in said camera.

19. The camera of claim 18 further comprising means for editing said information.

20. A camera containing an imaging system, a shutter activator coupled to a processor system that, when activated, causes a still picture of an image passing through said imaging system to be captured at an image receptor, the improvement comprising:
a processing module associated with said processor system
a microphone coupled to said processing module,
a sound recording activator coupled to said processing module and
a memory coupled to said processor module, where said processing module is conditioned to store, in said memory, input signals captured by said microphone in response to said sound recording activator for a duration that is independent of parameters associated with picture taking.

21. An image processing apparatus comprising:
means for receiving information of a still image,
means receiving speech information associated with said still image,
means for converting said speech information to text,
means for capturing said image, and said text in association with said image.

22. The apparatus of claim 21 constituting a camera where said means for capturing is an electronic memory module, photographic film, or photographic paper.

23. The apparatus of claim 21 constituting a picture printing apparatus.

24. The apparatus of claim 21 embodied in a computer and a printer combination.

25. A film cartridge comprising film, and an electronic storage element.
